(19) United States
(12) Patent Application Publication
(10) Pub. No.: US 2012/0288274 A1
(43) Pub. Date: Nov. 15, 2012

(54) OPTICAL NETWORK SYSTEM AND DEVICES ENABLING DATA, DIAGNOSIS, AND MANAGEMENT COMMUNICATIONS

(76) Inventor: Wen Li, San Ramon, CA (US)

(21) Appl. No.: 13/107,919

(22) Filed: May 15, 2011

(51) Int. Cl. H04B 17/00

(52) U.S. Cl. 398/16

(57) ABSTRACT

An optical transmitter module includes an optical transmitter configured to emit a first optical signal that includes a user data signal having a first frequency and comprising user data associated with the first communication channel. A management diagnostic modulator can superimpose a diagnostic waveform to the user data signal. The diagnostic waveform has a second frequency associated with the first communication channel, wherein the second frequency is in a frequency range between about 10 KHz and about 10 MHz. A management unit can modulate the diagnostic waveform by a management data signal at a third frequency associated with the first communication channel. The management data signal includes management data for digital diagnostic monitoring signals (DDM) and the control of the first optical transceiver module.

### BACKGROUND OF THE INVENTION

The present disclosure relates to optical networking systems and optical transceivers used in the optical networking systems.

As voice over Internet Protocol (VoIP) and Internet Protocol television (IPTV) grow in popularity, an increasing number of users desire to have access to these services from their premises. Similarly, businesses now require more bandwidth available to their premises with necessary quality of service. To meet these needs, network carriers are building optical access networks with different network topologies such as fiber-to-the-premises, fiber-to-the-node, or fiber-to-the-building with many different access transport solutions.

As service provides' networks are becoming more complex, reliable services and effective management of the networks have become key challenges for service providers to ensure service level agreement (SLA) and guarantee customer satisfaction.

### SUMMARY OF THE INVENTION

Embodiments may include one or more of the following advantages. The presently disclosed optical system and optical transceiver device provide more reliable optical communications comprising users' data as well as diagnosis and management information. The diagnosis and management information are transmitted in optical layer communication channels that are non-intrusive to the user data traffic. The disclosed systems and methods can eliminate the needs for demarcation equipment in some conventional optical network systems.

An important feature of the presently disclosed optical system and optical transceiver device is that the diagnosis and management information is transmitted in channel-specific signals. In other words, the signals carrying the diagnosis and management information have signatures for communication channels. The status monitoring and control of the equipment can be conducted for each channel even when the optical link transmits user-data optical signals for different channels.

Moreover, user communication can be managed, monitored, and diagnosed specific to each user communication channel. Furthermore, the encoding and extraction of diagnosis signals can be provided with simple algorithmic and hardware implementations as part of or separate from an optical transceiver.

In a general aspect, the present specification relates to an optical transmitter module that includes an optical transmitter that can emit a first optical signal that includes a user data signal having a first frequency and comprising user data associated with the first communication channel, wherein the first frequency is higher than 1 Gbps; a management diagnostic modulator that can superimpose a diagnostic waveform to the user data signal, wherein the diagnostic waveform has a second frequency associated with the first communication channel, wherein the second frequency is in a frequency range between about 10 KHz and about 10 MHz; and a management unit that can modulate the diagnostic waveform by a management data signal at a third frequency associated with the first communication channel, wherein the management data signal comprises management data for digital diagnostic monitoring signals (DDM) and the control of the first optical transceiver module, wherein the first optical signal comprises the user data signal and the diagnostic waveform that is modulated by the management data signal.

In another general aspect, the present specification relates to an optical receiver module for multi-channel communication that includes an optical receiver that can convert an optical signal into an electric signal, wherein the optical signal comprises the user data signal and a diagnostic waveform that is modulated by a management data signal, wherein the user data signal comprises user data in a first communication channel and has a first frequency associated with first communication channel, wherein the first frequency is higher than 1 Gbps, wherein the diagnostic waveform has a second frequency associated with the first communication channel, wherein the second frequency is in a frequency range between about 10 KHz and about 10 MHz, wherein the management data signal has a third frequency specific to the first communication channel, wherein the third frequency is in a frequency range between about 1 KHz and about 100 KHz; and a management diagnostic demodulator that can extract the diagnostic waveform from the electric signal and to extract the diagnostic waveform at the second frequency specific for the first communication channel, and to extract, from the diagnostic waveform, the management data signal and the management data specific for the first communication channel.

In another general aspect, the present specification relates to a multi-channel optical network system that includes a first optical transceiver module that includes an optical transmitter that can emit a first optical signal associated with a first communication channel that includes a user data signal having a first frequency and comprising user data in a first communication channel, wherein the first frequency is higher than 1 Gbps; a management diagnostic modulator that can superimpose a diagnostic waveform to the user data signal, wherein the diagnostic waveform has a second frequency associated with the first communication channel, wherein the second frequency is in a frequency range between about 10 KHz and about 10 MHz; and a first management unit that can modulate the diagnostic waveform by a management data signal at a third frequency, wherein the management data signal comprises management data for digital diagnostic monitoring signals (DDM) and the control of the first optical transceiver module, wherein the first optical signal comprises the user data signal and the diagnostic waveform that is modulated by the management data signal. The multi-channel optical network system includes a second optical transceiver module that includes a receiver that can convert the first optical signal to an electric signal; and a management diagnostic demodulator that can extract the diagnostic waveform at the second frequency from the electric signal in order to monitor the operation status of the optical network system specific for the first communication channel, wherein the management diagnostic demodulator can demodulate the diagnostic waveform to extract the management data signal and the management data specific for the first communication channel.

In yet another general aspect, the present specification relates to a multi-channel optical network system for transmitting user data in a plurality of communication channels which includes a first optical transceiver module that includes an optical transmitter that can emit a first optical signal that includes a user data signal having a first frequency associated with a first communication channel, wherein the user data signal comprises user data in a first communication channel, wherein the first frequency is higher than 1 Gbps; a management diagnostic modulator that can superimpose a diagnostic waveform to the user data signal, wherein the diagnostic waveform has a second frequency associated with the first communication channel, wherein the second frequency is in a frequency range between about 10 KHz and about 10 MHz; and a management unit that can modulate the diagnostic waveform by a management data signal at a third frequency associated with the first communication channel, wherein the management data signal comprises management data for digital diagnostic monitoring signals (DDM) and the control of the first optical transceiver module, wherein the first optical signal comprises the user data signal and the diagnostic waveform that is modulated by the management data signal. The multi-channel optical network system also includes a second optical transceiver module that can convert the first optical signal to a first electric signal to extract user data in the first communication channel, wherein the first transmitter transmits the first optical signal to the second optical transceiver module via a first optical fiber; and an optical snooper that can tap a portion of the first optical signal in the first optical fiber and to extract the diagnostic waveform at the second frequency specific in the first communication channel and to extract, from the diagnostic waveform, the management data signal and the management data for the first communication channel.

In still another general aspect, the present specification relates to a method for transmitting user data in a plurality of communication channels in a multi-channel optical network. The method includes specifying a first frequency, a second frequency, and a third frequency associated with a first communication channel among the plurality of communication channels, wherein the first frequency is higher than 1 Gbps, wherein the second frequency is in a frequency range between about 10 KHz and about 10 MHz, wherein the third frequency is higher than the second frequency; transmitting a first optical signal by an optical transmitter in the optical network, wherein the first optical signal includes a user data signal at the first frequency, wherein the user data signal comprises user data in a first communication channel; superimposing a diagnostic waveform at the second frequency on to the user data signal; and modulating the diagnostic waveform by a management data signal, wherein the management data signal comprises management data for digital diagnostic monitoring signals (DDM) and the control of the first optical transceiver module, wherein the first optical signal comprises the user data signal and the diagnostic waveform that is modulated by the management data signal.

Implementations of the system may include one or more of the following. The third frequency can be in a frequency range between about 1 KHz and about 100 KHz. The amplitude of the diagnostic waveform can be between about 1% and 10% of the amplitude of the user data signal. The optical transmitter module can further include a driver that can drive the optical transmitter in accordance to the user data signal, the diagnostic waveform, and the management data signal. The optical transmitter module can further a first current sink coupled with the optical transmitter, the first current sink that can be modulated by the user data signal, wherein the first optical signal emitted by the optical transmitter is modulated by the first current sink. The optical transmitter module can further a second current sink coupled with the optical transmitter, the second current sink that can be modulated by the diagnostic waveform that is in turn modulated by the management data signal, wherein the first optical signal emitted by the optical transmitter is modulated by the second current sink. The second current sink can include a modulation current that has a constant DC level to eliminate optical power fluctuations in the optical transmitter. The management diagnostic modulator can further include a programmable oscillator that can receive the management data signal to produce a modulation signal that comprises the diagnostic waveform modulated by the management data signal, wherein the management diagnostic modulator is that can send the modulation signal to modulate the second current sink. The management diagnostic modulator can tune the second frequency to the first communication channel in response to a frequency control signal.

Although the specification has been particularly shown and described with reference to multiple embodiments, it will be understood by persons skilled in the relevant art that various changes can be made therein in form and details without departing from the spirit and scope of the specification.

### BRIEF DESCRIPTION OF THE DRAWINGS

FIG. 1A is a block diagram of an exemplified multi-channel optical network system with pluggable smart transceivers that provide optical-layer management and diagnostic waveform in accordance to the present invention.

FIG. 1B illustrates transmitting and receiving signals carrying a management data signal, a diagnostic waveform, and high-speed user data signal inside a smart transceiver in FIG. 1A.

FIG. 2A illustrates an optical signal comprising high-speed user data signal in an nth channel.

FIG. 2B illustrates a diagnostic waveform modulated by a management data signal in accordance to the present invention.

FIG. 2C illustrates an optical signal comprising user data signal and added with a diagnostic waveform modulated by a management data signal in accordance to the present invention.

FIG. 3 is a detailed block diagram of an optical transceiver capable of transmitting and receiving high-speed user data signal, optical-layer management data, and diagnostic waveforms in a multi-channel optical network in accordance to the present invention.

FIG. 4 illustrates an exemplified implementation of the management diagnostic modulator in an optical transceiver in accordance to the present invention.

FIG. 5 illustrates an exemplified implementation of the management diagnostic demodulator in an optical transceiver in accordance to the present invention.

FIG. 6 is a block diagram of another exemplified multi-channel optical network system that can provide optical-layer management data and diagnostic waveform monitoring in accordance to the present invention.

FIG. 7 is a block diagram of an exemplified optical snooper with diagnostic waveform monitoring capability in the multi-channel optical network system in accordance to the present invention.

### DETAILED DESCRIPTION OF THE INVENTION

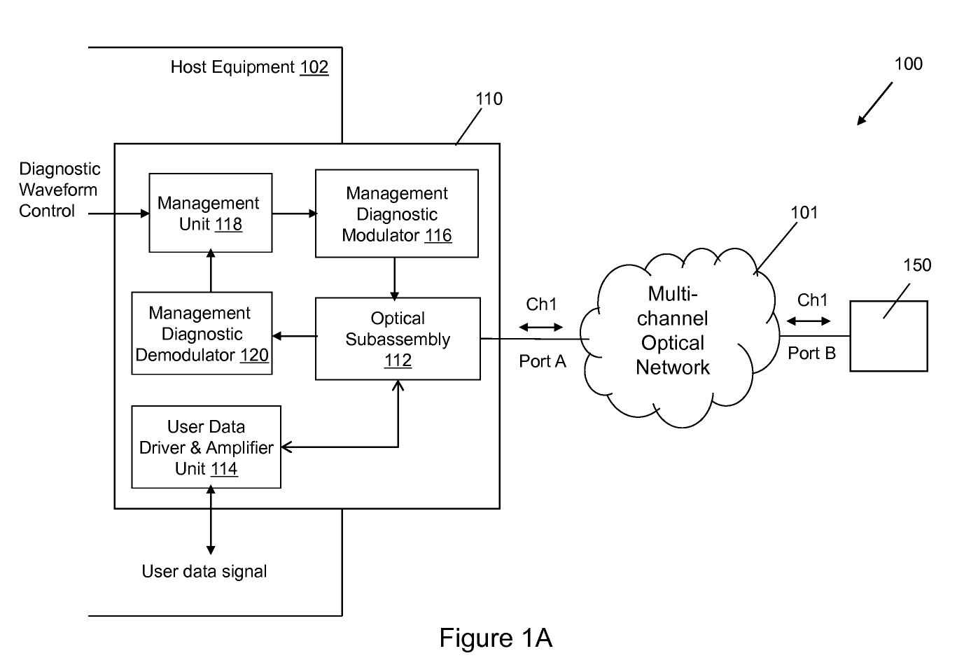

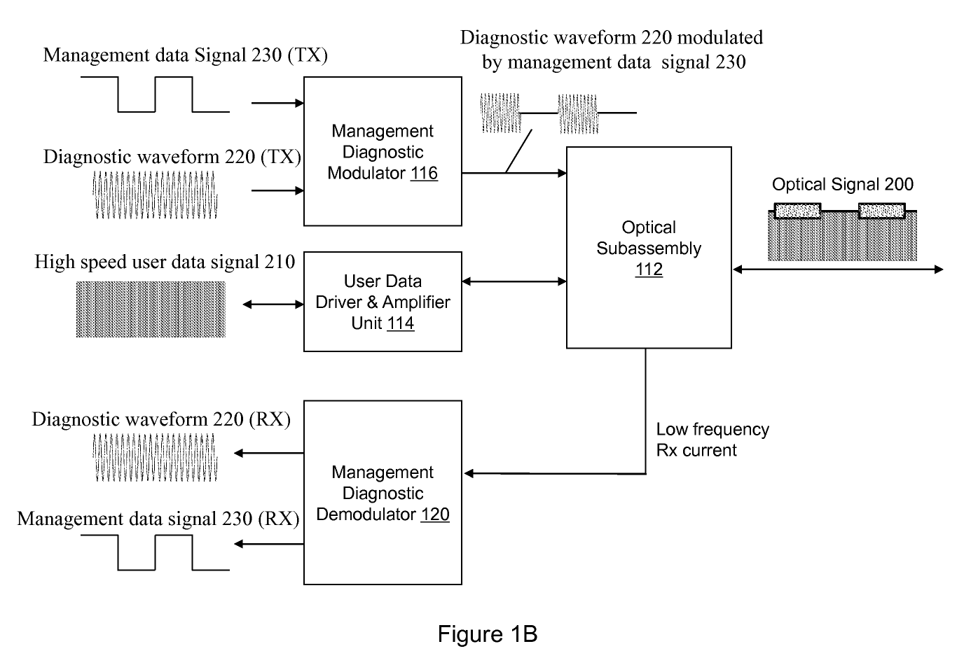

Referring to FIGS. 1A and 1B, a multi-channel optical network system 100 includes a multi-channel optical network 101 that include plurality of ports for optical communications in multiple channels “Ch1”, “Ch2”. . . “Ch N”. Specifically, Port A and Port B are respectively connected to optical transceivers 110 and 150 for communication in the channel “Ch 1”.

The optical transceiver 110 includes an optical subassembly 112, a data driver & amplifier unit 114, a management diagnostic modulator 116, a management diagnostic demodulator 120, and a management unit 118. The optical subassembly 112 is configured to transmit and receive optical signals. The data diver & amplifier unit 114 is configured to transmit and receive a user data signal from host equipment 102. In the present specification, the term “user data” refers to the data that carries information to be communicated between users at different points in an optical communication network. For example, “user data” can be in many forms, such as Ethernet, SONET/SDH, ATM, etc., and carries many types of information, such as documents, emails, web content, image data, voice data, video data, etc.

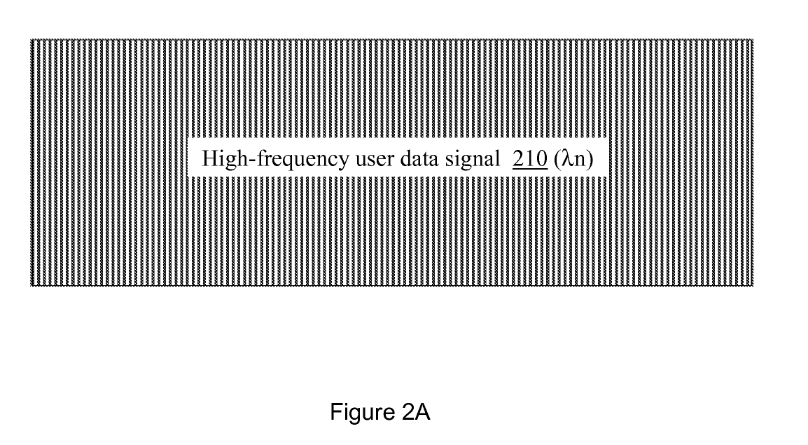

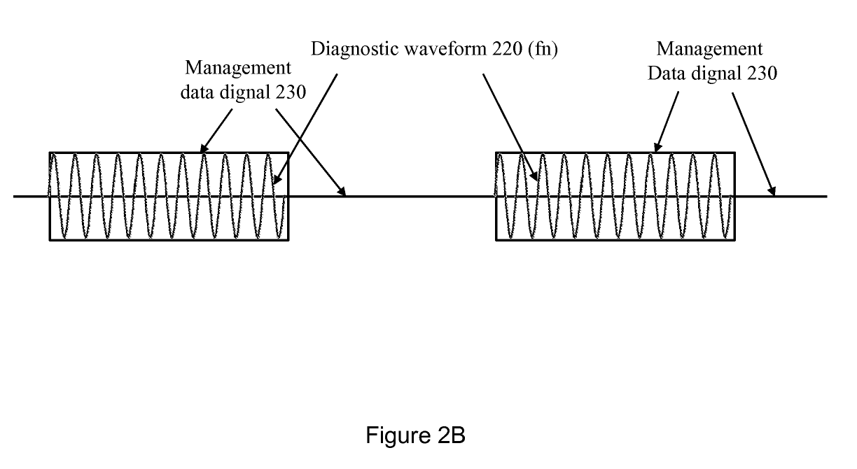

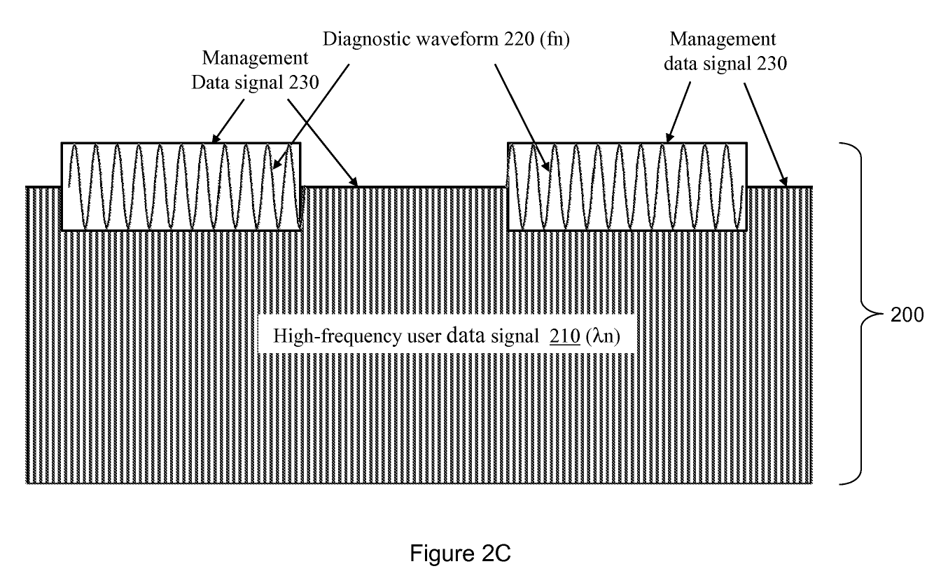

The data driver & amplifier unit 114 interfaces with the optical subassembly 112 which transmits and receives the user data in a high-frequency user data signal 210 as shown in FIGS. 1B and 2A. The user data signal 210 typically has a frequency equal to or higher than about 1 Gbps. For different channels, the user-data signals are respectively transmitted at different wavelengths λ1, λ2, λn.

Still referring to FIGS. 1A and 1B, the management unit 118 stores, generates, and processes “diagnostic waveform” and “management data signal”. In the present application, “diagnostic waveform” refers to waveforms used by equipment to implement channel monitoring capability in a multi-channel optical communication network. “Management data signal” refers to a signal comprising management data used by equipment to monitor operational status and assure proper operations of an optical communication network. For example, management data includes optical power, operational temperature, and other parameters defined in SFF-8472. Diagnostic waveform can be a sinusoidal tone signal in a DWDM system, where tone frequency represents optical wavelength, and tone amplitude represents optical power level.

The management unit 118 sends or receives “diagnostic waveform” and “management data signal” to and from the management diagnostic modulator 116 and demodulator 120 respectively. To transmit the “diagnostic waveform”, the management unit 118 produces a low-amplitude mid-frequency diagnostic waveform 220, as shown in FIGS. 1B and 2B. The diagnostic waveform 220 is an oscillatory signal such as a sinusoidal waveform. The diagnostic waveform 220 can be in a frequency range between about 10 KHz and about 10 MHz. The amplitude of the diagnostic waveform 220 can be between about 1% and 10% of the amplitude of the user data signal 210. For different channels, the diagnostic waveforms are respectively transmitted at different frequencies f1, f2 . . . fn.

The diagnostic waveform 220 is modulated by a management data signal 230 that has a lower frequency than that of the diagnostic waveform 220. The management data contained in the management data signal 230 comprises DDM (digital diagnostic monitoring signals) and the control of a remove optical transceiver (e.g. 150). The management data signal 230 can be in the form of a square wave comprising amplitudes of “1” and “0” as shown in FIG. 2B with a frequency range (i.e. data rate) between about 1 KHz and about 100 KHz.

The diagnostic waveform 220 modulated by the management data signal 230 is mixed or superimposed to the user data signal 210 to for an optical signal 200, as shown in FIGS. 1B and 2C. The high-frequency user data signal 210 is often referred to “in-band” signals. The diagnostic waveform 220 and the management data signal 230 are “transparent”, “out-of-band”, and “non-intrusive” to the user data signal 210. One significant advantageous feature of the prevent invention system and method is that the “out-of-band” diagnostic and management data include channel specific signatures such that management information can be detected for each channel even in optical signals from multiple channels.

Referring to FIGS. 1A and 1B, the optical transceiver 150 can have similar components to those in the optical transceiver 110. In other words, the optical transceiver 150 can send an optical signal comprising high frequency user-data signal and a diagnostic waveform 220 modulated by a management data signal 230. The optical transceivers 110 and 150 also have functions for extracting the diagnostic data and the management data signal 230 from the optical signals 200.

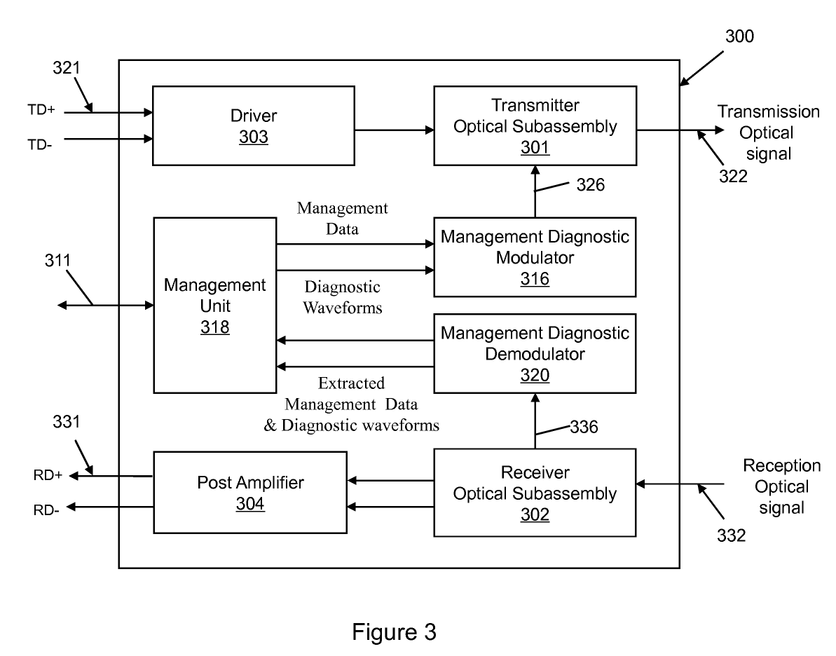

Referring to FIG. 3, an optical transceiver 300 compatible with the optical transceivers 110 and 150 includes a driver 303 that receives differential data signals TD+ and TD− carrying user data for transmission at a transmission electrical interface 321. Driven by the driver 303, a transmitter optical subassembly (TOSA) 301 emits a transmission optical signal at a transmission optical interface 322. The driver 303 can be in the form of a laser diver chip or an external modulator that can modulate continuous wave optical signals from TOSA 301. The transmission optical signal carries a user data signal and diagnostic waveforms modulated by a management data signal in the same fashion as the optical signal 200 (FIG. 1B). The output optical signal is transmitted to the multi-channel optical network 101 (via Port A, Port B etc. in FIG. 1A).

A reception optical signal similar to the optical signal 200 (FIG. 2) is received at a reception optical interface 332 from a remote device via the multi-channel optical network 101 (FIG. 1A). The reception optical signal can be converted by a receiver optical subassembly (ROSA) 302 to reception electrical signals, which are further amplified by a post amplifier 304 to output differential data signals RD+ and RD− at a reception electrical interface 331.

It should be noted that the transmission signal received by the driver 303 and the reception signals output by the post amplifier 304 are not limited to differential signals. Both signals can also be compatible with single-ended signals. The functional blocks and components in the optical transceiver 300 can be separate physical devices. Several functional blocks can be integrated into a unitary device. For example, the transmitter optical subassembly 301 and the receiver optical subassembly 302 can be integrated in a bidirectional optical subassembly with a bidirectional optical interface that can output transmission optical signal 322 and receive reception optical signal 332.

A management unit 318 (similar to 118 in FIG. 1A) can monitor and control the operations of the optical transceiver 300 as well as the operations of a remote optical transceiver in communication with the optical transceiver 300 (e.g. the optical transceiver 150 relative to the optical transceiver 110 in FIG. 1A). The management unit 318 can output status and other signals and receive control signals at an interface 311.

A management diagnostic modulator 316 (similar to 116 in FIG. 1A) is configured to generate a management diagnostic waveform shown in FIG. 2B, and superimpose the management-data modulated diagnostic waveform on the high-speed user data signal by driving or modulating the transmitter optical subassembly 301. A management diagnostic demodulator 320 (similar to 120 in FIG. 1) is configured to receive signals from a receiver optical subassembly 302, and extract the management data signal and the diagnostic waveform.

In the transmission path, the management diagnostic modulator 316 receives “a management data signal” and “diagnostic waveform” from the management unit 318. The diagnostic waveform can be generated in the management unit 318 or received from outside by the management unit 318. The management diagnostic modulator 316 produces a modulation control signal 326 that can modulate the transmitter in the transmitter optical subassembly 301 to produce the mid-frequency diagnostic waveform modulated by the low-frequency management data signal in the high-frequency user-data signal in the transmission optical signal, as shown in FIG. 1B. In some embodiments, the modulation control signal 326 can modulate bias voltage or current in the driver 303 to produce a low speed and small amplitude envelope modulation over the differential data signals (TD+ and TD−).

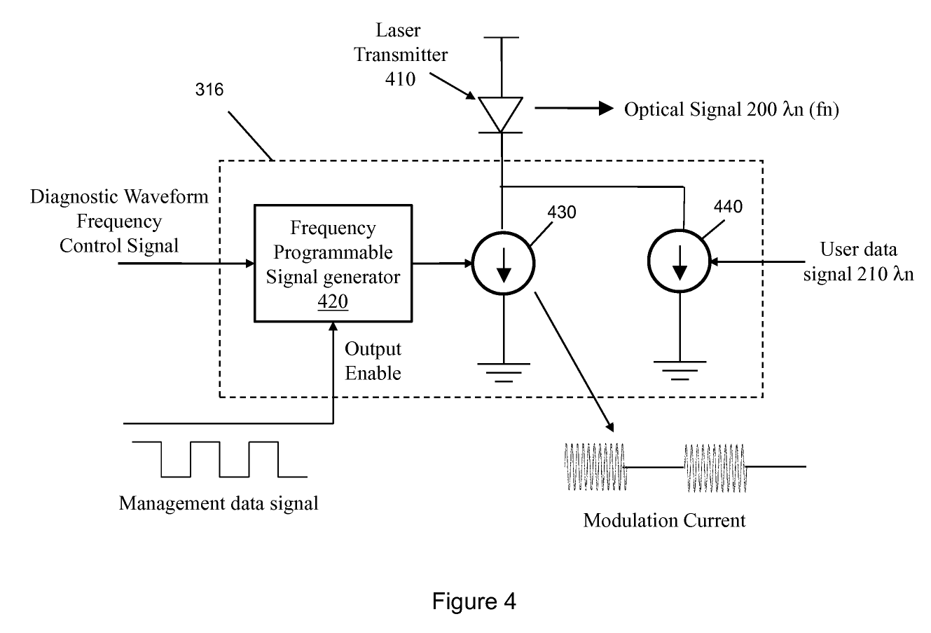

In one exemplified implementation, referring to FIG. 4, the management diagnostic modulator 316 can modulate the current passing through a laser transmitter 410 in the transmitter optical subassembly 301. The management diagnostic modulator 316 includes a programmable frequency signal generator 420, a modulation current sink 430. A current sink 440 is used for provide bias and modulation in response to the high-speed user data signal generated by the driver 303 in FIG. 3.

The programmable frequency signal generator 420 receives the frequency control signal from the management unit 318 and generates an oscillation signal having a frequency specific to the communication channel for the optical transceiver 300. The frequency of the oscillation signal can range between about 10 KHz and about 10 MHz (i.e. RF frequency range), which corresponding to the frequency of the diagnostic waveform shown in FIG. 1B. The management data signal is received by the output enable of the programmable frequency signal generator 420. The management data signal can be sent by the management unit 318 in a 1/0 digital signal that is compatible with the management data signal (in FIG. 1B). The programmable frequency signal generator 420 can then output a modulation signal to drive the modulation current sink 430. The modulation current has a waveform that mimics the diagnostic waveform 220 and the management data signal 230 shown in FIG. 1B. The current sink 440 is modulated by a high-speed user data signal 210 shown in FIG. 2A. The laser transmitter 410 is driven by the current sinks 430 and 440, which outputs the transmission optical signal having waveforms in the same fashion as the topical signal 200 as shown in FIG. 1B. The user-data signal is transmitted at a wavelength λn corresponding to the nth channel. The diagnostic waveform has a frequency fn that selected by the programmable frequency signal generator 420, also corresponding to the nth channel. Thus the diagnostic waveform carries a signature for the specific channel and can be used for diagnosing transmission or equipment issues specific to a communication channel.

Referring again to FIG. 4, an optical signal at wavelength λn can be considered as the first carrier, on which high-speed user data signal is modulated. The high-speed user data signal at 1 Gbps and above can be considered as the second carrier, which is modulated by or superimposed with a diagnostic waveform. The diagnostic waveform with frequency usually between 10 kHz and 10 MHz is then used as the third carrier, which is modulated by the management data signal. In the exemplified implementation shown in FIG. 4, on-off keying (OOK) is used in modulation by the management data signal. In one embodiment of the present invention, the modulation current in the current sink 430 is configured to have a constant DC level to eliminate optical power fluctuations.

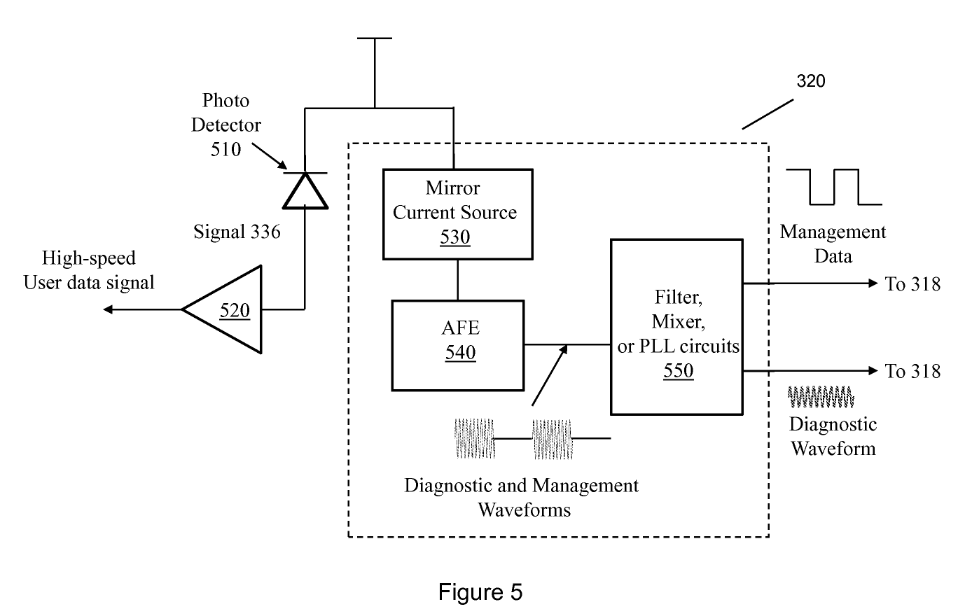

In the reception path, referring to FIGS. 1B and 3, the management diagnostic demodulator 120 or 320 is configured to extract management data from the reception optical signal that has waveforms similar to the optical signal 200. A portion of the reception optical signal received by the ROSA 302 can be sent as a signal 336 to the management diagnostic demodulator 320. In one exemplified implementation, referring to FIG. 5, the management diagnostic demodulator 320 includes a mirror current source 530, an AFE (analog front end) circuitry 540, and a filter/Mixer/PLL(phase locked loop) circuits 550 to further separate the management data signal and the diagnostic waveform. The photo current generated in response to the signal 336 is replicated in the mirror current source 530. Analog front end (AFE) 540 separates the high frequency user data signal and outputs the diagnostic waveform and the management data signal, which is subsequently processed by the filter/Mixer/PLL circuits 550 to separate the mid-frequency diagnostic waveforms and low frequency management data signal. Both management data signal and diagnostic waveform are output to the management unit 318.

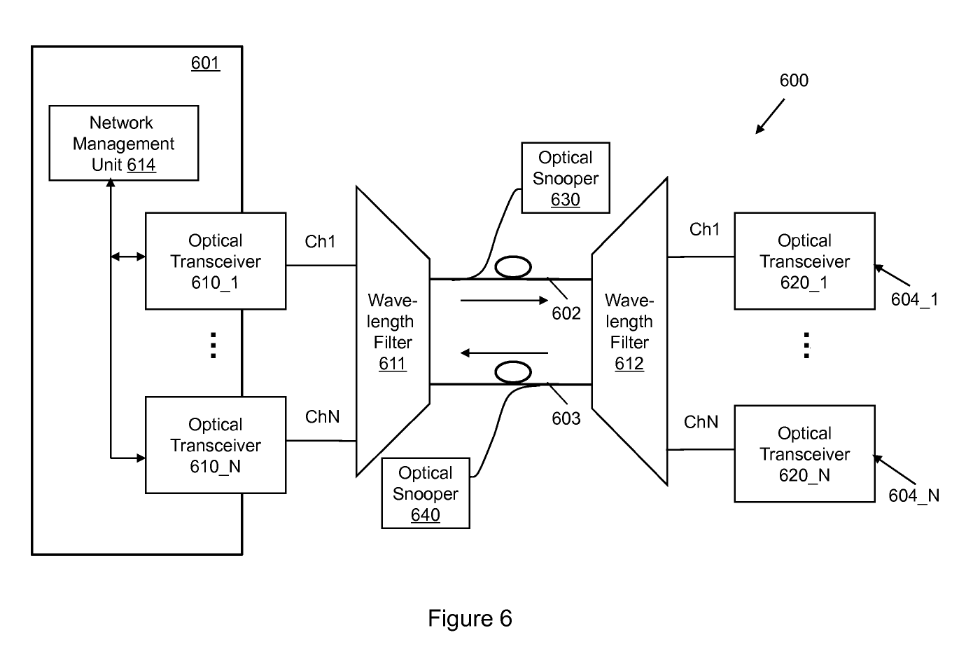

In some embodiments, referring to FIG. 6, a multiple-channel optical network system 600 includes a wavelength filter 611 and a wavelength filter 612. The wavelength filters 611 and 612 include common ports connected to optical link 602, 603, which can be formed by a single optical fiber or a cable containing a bundle of optical fiber. Each of the wavelength filters 611 and 612 also includes a plurality of branching ports that respectively transmit optical signals in different wavelength channels “Ch1”, “Ch2” . . . “Ch N”. The branching ports of wavelength filter 611 at the network equipment 601 are connected to optical transceivers 610_1, 610_2 . . . 610_N. The optical transceivers 610_1, 610_2 . . . 610_N can be plugged into network equipment 601. The network equipment 601 also includes a network management unit 614 in communication with the optical transceivers 610_1, 610_2 . . . 610_N. Similarly, the branching ports of the wavelength filter 612 are respectively connected to optical transceivers 620_1, 620_2 . . . 620_N that are plugged into one or more network equipments at different location(s).

The optical network system 600 can provide communications between a pair of optical transceivers in different communication channels. The communication channels can be dedicated between two points and are independent from other channels. For example, the communications in channel 1 (i.e. “Ch1”) between the optical transceiver 610_1 and the optical transceiver 620_1 are through dedicated branching ports in the wavelength filters 611 and 612.

The optical transceivers 610_1, 610_2 . . . 610_N, 620_1, 620_2 . . . 620_N can each emit optical signals comprising a user data signal, the diagnostic waveform and the management data signal as shown by the optical signal 200 (in FIG. 1B). Importantly, the diagnostic waveform and the management data signal have signatures specific in their respective channels. The optical transceivers 610_1, 610_2 . . . 610_N, 620_1, 620_2 . . . 620_N include diagnostic management modulators and demodulators similar to the management diagnostic demodulator 320 in the optical transceiver 300 (FIG. 3).

In some embodiments, the optical network system 600 can include optical snoopers 630, 640 that provide additional diagnostic monitoring functions. The optical snooper 630 can tap, at the optical link 602, the optical signals from the optical transceivers 610_1, 610_2 . . . 610_N to the optical transceivers 620_1, 620_2 . . . 620_N. The optical snooper 630 can extract the diagnostic waveforms and the management data signal in the optical signals in each of the different channels in order to monitor the status of the optical network system 600. Similarly, an optical snooper 640 can tap, at the optical link 603, the optical signals from the optical transceivers 620_1, 620_2 . . . 620_N to the optical transceivers 610_1, 610_2 . . . 610_N. The optical snooper 640 can extract the diagnostic waveform and the management data signal in the optical signals in each of the different channels in order to monitor the status of the optical transceivers 620_1, 620_2 . . . 620_N.

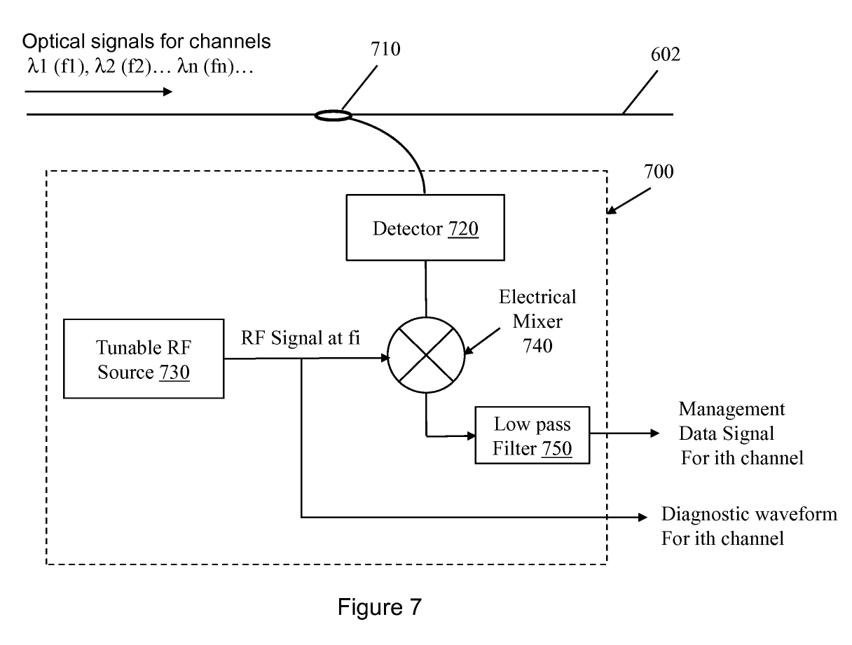

Referring to FIG. 7, an exemplified optical snooper 700 that is compatible with the optical snooper 630 and 640 can include a detector 720, a tunable RF source 730, and an electrical mixer 740. The optical link 602 transmits optical signals for a plurality of optical channels “Ch1”, “Ch2” . . . “Ch N”, which have the user data signals (210 in FIG. 2C) respectively at wavelengths λ1, λ2, λn and diagnostic waveforms (220 in FIG. 2C) respectively at mid frequencies f1, f2 . . . fn. A fiber tap 710 can tap a portion of the optical signals in the optical link 602. The optical signal is then converted into electrical signal by the detector 720. The tunable RF source can be tuned to output an RF signal at a mid-frequency fi that corresponds to the ith channel. The RF signal at a mid-frequency fi is mixed with the electrical signals from detector 720 by the electrical signal mixer 740, then processed by a low-pass filter 750 to output a management data signal corresponding to the ith channel. The RF frequency fi of the tunable source 730 represents optical wavelength of the ith channel. Signal amplitude from the low-pass filter 750 is proportional to optical power of the ith channel.

In some embodiments, the optical snooper 630 can reside in one of the optical transceivers 610_1 . . . 610_N similar to the optical transceiver 300 (FIG. 3). The optical snooper 640 can also reside in the optical transceiver 620_1 . . . 620_N similar to the optical transceiver 300 (FIG. 3).

The optical snooper can be used detect failure modes. For example, in a WDM system, optical snooper 630 and 640 can be deployed at various locations of the optical network. By changing the tunable RF source 730, optical snooper can quickly scan entire optical spectrum, and monitor critical including optical wavelengths and powers. In addition, the optical snooper can receive the management data signal of a specific channel by tuning the RF source at a predetermined RF frequency. Traditional WDM channel monitor is designed at optical domain requiring optical WDM filters, which is very expensive.

It is understood that the specific configurations and parameters described above are meant to illustration the concept of the specification. The disclosed systems and methods can be compatible with variations of configurations and parameters without deviating from the spirit of the present invention. For example, the low-amplitude envelop modulation of the diagnostic waveform can be in other waveforms than the ones disclosed above. The disclosed system and methods can utilize other modulation and demodulation techniques, such as and not limited to, frequency modulation and phase modulation. The disclosed optical transceivers, optical communication network, and optical communication systems can include additional components or have different construction as described above. The disclosed optical transceivers can be compatible with industry standards such as Small Form Factor (SFF), Small Form-factor Pluggable (SFP), Bi-directional Small Form-factor Pluggable (Bi-direction SFP), and other standards for optical transceiver modules. The disclosed system and methods are compatible with active and passive devices, and point-to-point or point-to-multi-point optical networks.

What is claimed is:

1. An optical transmitter module, comprising:
an optical transmitter configured to emit a first optical signal that includes a user data signal having a first frequency and comprising user data associated with the first communication channel, wherein the first frequency is higher than 1 Gbps;
a management diagnostic modulator configured to superimpose a diagnostic waveform to the user data signal, wherein the diagnostic waveform has a second frequency associated with the first communication channel, wherein the second frequency is in a frequency range between about 10 KHz and about 10 MHz; and
a management unit configured to modulate the diagnostic waveform by a management data signal at a third frequency associated with the first communication channel, wherein the management data signal comprises management data for digital diagnostic monitoring signals (DDM) and the control of the first optical transceiver module, wherein the first optical signal comprises the user data signal and the diagnostic waveform that is modulated by the management data signal.

2. The optical transmitter module of claim 1, wherein the third frequency is in a frequency range between about 1 KHz and about 100 KHz.

3. The optical transmitter module of claim 1, wherein the amplitude of the diagnostic waveform is between about 1% and 10% of the amplitude of the user data signal.

4. The optical transmitter module of claim 1, further comprising a driver configured to drive the optical transmitter in accordance to the user data signal, the diagnostic waveform, and the management data signal.

5. The optical transmitter module of claim 1, further comprising a first current sink coupled with the optical transmitter, the first current sink configured to be modulated by the user data signal, wherein the first optical signal emitted by the optical transmitter is modulated by the first current sink.

6. The optical transmitter module of claim 5, further comprising a second current sink coupled with the optical transmitter, the second current sink configured to be modulated by the diagnostic waveform that is in turn modulated by the management data signal, wherein the first optical signal emitted by the optical transmitter is modulated by the second current sink.

7. The optical transmitter module of claim 6, wherein the second current sink comprises a modulation current that has a constant DC level to eliminate optical power fluctuations in the optical transmitter.

8. The optical transmitter module of claim 6, wherein the management diagnostic modulator further comprises a programmable oscillator configured to receive the management data signal to produce a modulation signal that comprises the diagnostic waveform modulated by the management data signal, wherein the management diagnostic modulator is configured to send the modulation signal to modulate the second current sink.

9. The optical transmitter module of claim 8, wherein the management diagnostic modulator is configured to tune the second frequency to the first communication channel in response to a frequency control signal.

10. An optical receiver module for multi-channel communication, comprising:
an optical receiver configured to convert an optical signal into an electric signal, wherein the optical signal comprises the user data signal and a diagnostic waveform that is modulated by a management data signal, wherein the user data signal comprises user data in a first communication channel and has a first frequency associated with first communication channel, wherein the first frequency is higher than 1 Gbps, wherein the diagnostic waveform has a second frequency associated with the first communication channel, wherein the second frequency is in a frequency range between about 10 KHz and about 10 MHz, wherein the management data signal has a third frequency specific to the first communication channel, wherein the third frequency is in a frequency range between about 1 KHz and about 100 KHz; and
a management diagnostic demodulator configured to extract the diagnostic waveform from the electric signal and to extract the diagnostic waveform at the second frequency specific for the first communication channel, and to extract, from the diagnostic waveform, the management data signal and the management data specific for the first communication channel.

11. The optical receiver module of claim 10, wherein the amplitude of the diagnostic waveform is between about 1% and 10% of the amplitude of the user data signal.

12. A multi-channel optical network system, comprising:
a first optical transceiver module, comprising:
an optical transmitter configured to emit a first optical signal associated with a first communication channel that includes a user data signal having a first frequency and comprising user data in a first communication channel, wherein the first frequency is higher than 1 Gbps;
a management diagnostic modulator configured to superimpose a diagnostic waveform to the user data signal, wherein the diagnostic waveform has a second frequency associated with the first communication channel, wherein the second frequency is in a frequency range between about 10 KHz and about 10 MHz; and
a first management unit configured to modulate the diagnostic waveform by a management data signal at a third frequency, wherein the management data signal comprises management data for digital diagnostic monitoring signals (DDM) and the control of the first optical transceiver module, wherein the first optical signal comprises the user data signal and the diagnostic waveform that is modulated by the management data signal; and
a second optical transceiver module, comprising:
a receiver configured to convert the first optical signal to an electric signal; and
a management diagnostic demodulator configured to extract the diagnostic waveform at the second frequency from the electric signal in order to monitor the operation status of the optical network system specific for the first communication channel, wherein the management diagnostic demodulator is configured to demodulate the diagnostic waveform to extract the management data signal and the management data specific for the first communication channel.

13. The multi-channel optical network system of claim 12, wherein the third frequency is in a frequency range between about 1 KHz and about 100 KHz.

14. The multi-channel optical network system of claim 12, wherein the amplitude of the diagnostic waveform is between about 1% and 10% of the amplitude of the user data signal.

15. A multi-channel optical network system for transmitting user data in a plurality of communication channels, comprising:
a first optical transceiver module, comprising:
an optical transmitter configured to emit a first optical signal that includes a user data signal having a first frequency associated with a first communication channel, wherein the user data signal comprises user data in a first communication channel, wherein the first frequency is higher than 1 Gbps;
a management diagnostic modulator configured to superimpose a diagnostic waveform to the user data signal, wherein the diagnostic waveform has a second frequency associated with the first communication channel, wherein the second frequency is in a frequency range between about 10 KHz and about 10 MHz; and
a management unit configured to modulate the diagnostic waveform by a management data signal at a third frequency associated with the first communication channel, wherein the management data signal comprises management data for digital diagnostic monitoring signals (DDM) and the control of the first optical transceiver module, wherein the first optical signal comprises the user data signal and the diagnostic waveform that is modulated by the management data signal;
a second optical transceiver module configured to convert the first optical signal to a first electric signal to extract user data in the first communication channel, wherein the first transmitter transmits the first optical signal to the second optical transceiver module via a first optical fiber; and
an optical snooper configured to tap a portion of the first optical signal in the first optical fiber and to extract the diagnostic waveform at the second frequency specific in the first communication channel and to extract, from the diagnostic waveform, the management data signal and the management data for the first communication channel.

16. The multi-channel optical network system of claim 15, wherein the optical snooper comprises an electrical mixer configured to mix an electrical signal converted from a portion of the first optical signal with an oscillating signal at substantially the second frequency to extract the diagnostic waveform specific in the first communication channel.

17. The multi-channel optical network system of claim 15, wherein the third frequency is in a frequency range between about 1 KHz and about 100 KHz, wherein the amplitude of the diagnostic waveform is between about 1% and 10% of the amplitude of the user data signal.

18. A method for transmitting user data in a plurality of communication channels in a multi-channel optical network, comprising:
specifying a first frequency, a second frequency, and a third frequency associated with a first communication channel among the plurality of communication channels, wherein the first frequency is higher than 1 Gbps, wherein the second frequency is in a frequency range between about 10 KHz and about 10 MHz, wherein the third frequency is higher than the second frequency;
transmitting a first optical signal by an optical transmitter in the optical network, wherein the first optical signal includes a user data signal at the first frequency, wherein the user data signal comprises user data in a first communication channel;
superimposing a diagnostic waveform at the second frequency on to the user data signal; and
modulating the diagnostic waveform by a management data signal, wherein the management data signal comprises management data for digital diagnostic monitoring signals (DDM) and the control of the first optical transceiver module, wherein the first optical signal comprises the user data signal and the diagnostic waveform that is modulated by the management data signal.

19. The method of claim 18, further comprising tuning the diagnostic waveform to the second frequency in response to a frequency control signal, to cause the diagnostic waveform to be specific to the first communication channel.

20. The method of claim 18, further comprising converting the first optical signal to an electric signal by an optical receiver;
extracting the diagnostic waveform at the second frequency from the electric signal in order to monitor the operation status of the optical network; and
demodulating the diagnostic waveform to extract the management data signal and the management data specific for the first communication channel.

21. The method of claim 18, wherein the third frequency is in a frequency range between about 1 KHz and about 100 KHz, wherein the amplitude of the diagnostic waveform is between about 1% and 10% of the amplitude of the user data signal.
